(19) United States
(12) Patent Application Publication
(10) Pub. No.: US 2014/0334904 A1
(43) Pub. Date: Nov. 13, 2014

(54) DUMP CART

(71) Applicants: Larry Dean Howell, Longview, TX (US); Andy Ning Fan Kam, Hong Kong (CN); Jian Li, Hong Kong (CN)

(72) Inventors: Larry Dean Howell, Longview, TX (US); Andy Ning Fan Kam, Hong Kong (CN); Jian Li, Hong Kong (CN)

(73) Assignee: RANKAM (CHINA) MANUFACTURING CO. LTD, Hong Kong (CN)

(21) Appl. No.: 13/890,701

(22) Filed: May 9, 2013

(51) Int. Cl. B60P 1/32

(52) U.S. Cl. CPC B60P 1/32
USPC 414/477

(57) ABSTRACT

A dumping cart has a chassis, a first pair of supporting wheels located at a first end of the chassis and a second pair of supporting wheels located at a second end of the chassis. The second pair of wheels is rotational about a wheel axis. A load carrying bed is supported on the chassis and is pivotable about a dumping axis, between an intermediate dumping position and a load dumping position. A tipping member is pivotally connected with the chassis along the wheel axis and is pivotally connected with the bed along the dumping axis. The tipping member pivots about the wheel axis to move the bed between a load carrying position and the intermediate dumping position.

### TECHNICAL FIELD

The present invention relates to a dumping cart and particularly, although not exclusively, to a dumping cart which has a pivotal load carrying bed.

### BACKGROUND

Transporting goods from one place to another can be troublesome at times. For transportation of goods which are light, the transportation process may be performed manually by a person. However, for transporting goods that are bulky, it is often desirable to use vehicles. Such a vehicle could be a cart which can be self powered, or towed or pushed by a person, animal or another vehicle.

Often, apart from transporting the goods, the user may also want to dump the goods from the cart. These kinds of goods may include paper, clothings, farm products, livestock feed and dust or other waste items. The dumping action is usually carried out manually by shifting the entire cart which can be troublesome as a user will have to lift up the entire cart. However, a pivotal mechanism may also be used to ease the load on the user.

### SUMMARY OF THE INVENTION

In accordance with a first aspect of the invention, there is provided a dumping cart comprising: a chassis, a first pair of ground supporting wheels located at a first end of the chassis, a second pair of ground supporting wheels located at a second end of the chassis, the second pair of wheels being rotational about a wheel axis, a load carrying bed supported on the chassis and pivotal about a dumping axis between an intermediate dumping position and a load dumping position, and a tipping member pivotally connected with the chassis along the wheel axis and pivotally connected with the bed along the dumping axis, the tipping member pivots about the wheel axis to move the bed between a load carrying position and the intermediate dumping position.

In an embodiment of the first aspect, a handle is connected to the tipping member for actuating the tipping member, and the handle is in a first position in the load carrying position and a second position in the intermediate dumping position.

In an embodiment of the first aspect, the chassis comprises a plurality of frame members that define a first plane substantially parallel to the ground, and two of the frame members extend from the first plane at an angle to connect with the tipping member.

In an embodiment of the first aspect, the load carrying bed is substantially parallel to the first plane in the load carrying position and not parallel to the first plane in the intermediate dumping position and the load dumping position.

In an embodiment of the first aspect, a lift handle is connected to the load carrying bed, the lift handle can be actuated to allow the load carrying bed to pivot about the dumping axis between the intermediate dumping position and the load dumping position.

In an embodiment of the first aspect, a support bar with one end pivotally connected to the chassis and a second end connected to the load carrying bed supports the load carrying bed in the load dumping position.

In an embodiment of the first aspect, a steering handle assembly is pivotally connected to a steering assembly that connects the chassis, the steering handle assembly comprises a first member connected to a second member, wherein a handle is located at one end of the first member.

In an embodiment of the first aspect, the second member may be connected to an external vehicle that drives the dumping cart instead of to the first member.

In an embodiment of the first aspect, a lock pin locks the load carrying bed to the chassis in the load carrying position.

In an embodiment of the first aspect, the dumping cart further includes a supporting bar pivotally connected with the chassis at a first end of the bar and slidably engaging the load carrying bed at the second end of the bar, the supporting bar supporting the load carrying bed in the load dumping position.

In an embodiment of the first aspect, the dumping cart further includes rollers supporting the load carrying bed on the chassis. Preferably, although not exclusively, the rollers comprise at least a first pair of rollers on the chassis and a second pair of rollers on the load carrying bed.

### BRIEF DESCRIPTION OF THE DRAWINGS

Embodiments of the present invention will now be described, by way of example, with reference to the accompanying drawings in which:

FIG. 1A is a front isometric view of a dumping cart in accordance with one embodiment of the present invention,

FIG. 1B is a rear isometric view of the dumping cart of FIG. 1A,

FIG. 2 is an exploded view of the dumping cart of FIG. 1A,

FIGS. 3A and B are exploded views of the chassis of the dumping cart of FIG. 1A, and

FIGS. 4A-D is an illustration of the procedures for actuating the dumping cart of FIG. 1A from a load carrying position to a load dumping position in accordance with one embodiment of the present invention.

### DETAILED DESCRIPTION OF THE PREFERRED EMBODIMENT

The following description is given by way of example only to illustrate the invention and is not intended to limit the scope of use or functionality of the invention. In particular, the invention is not limited in its application to the details of construction and the arrangements of components set forth in the following description or illustrated in the accompanying drawings. The invention is capable of other embodiments and of being practiced or being carried out in various ways. Also, it is to be understood that the phraseology and terminology used is for the purpose of description and should not be regarded as limiting.

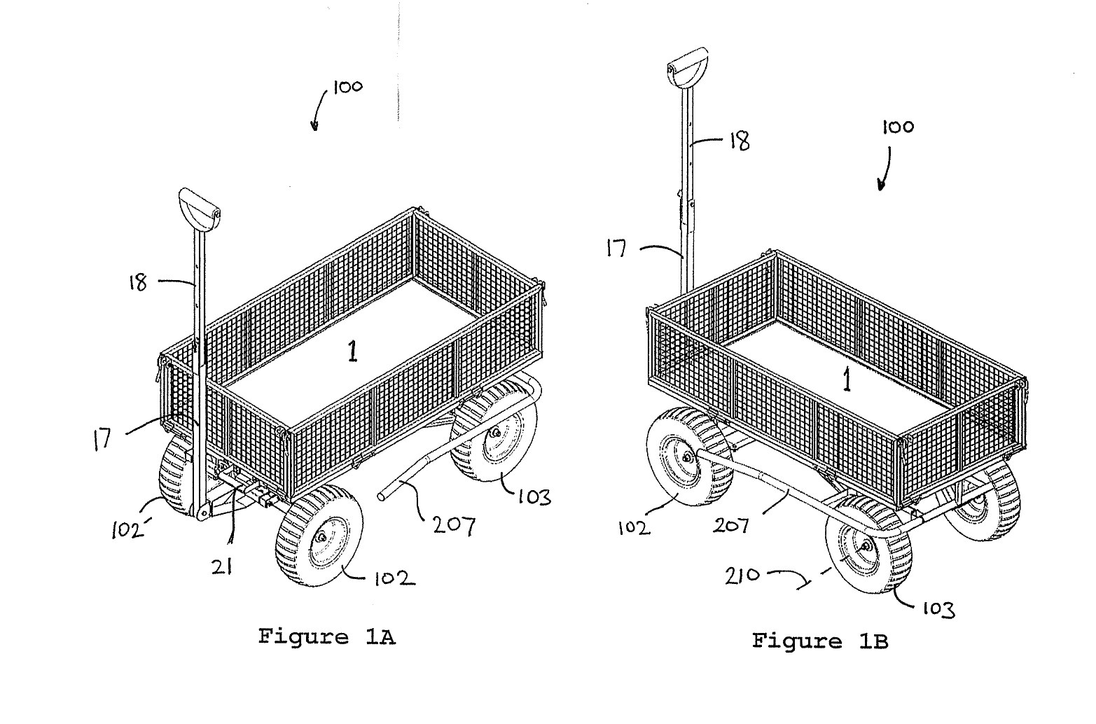

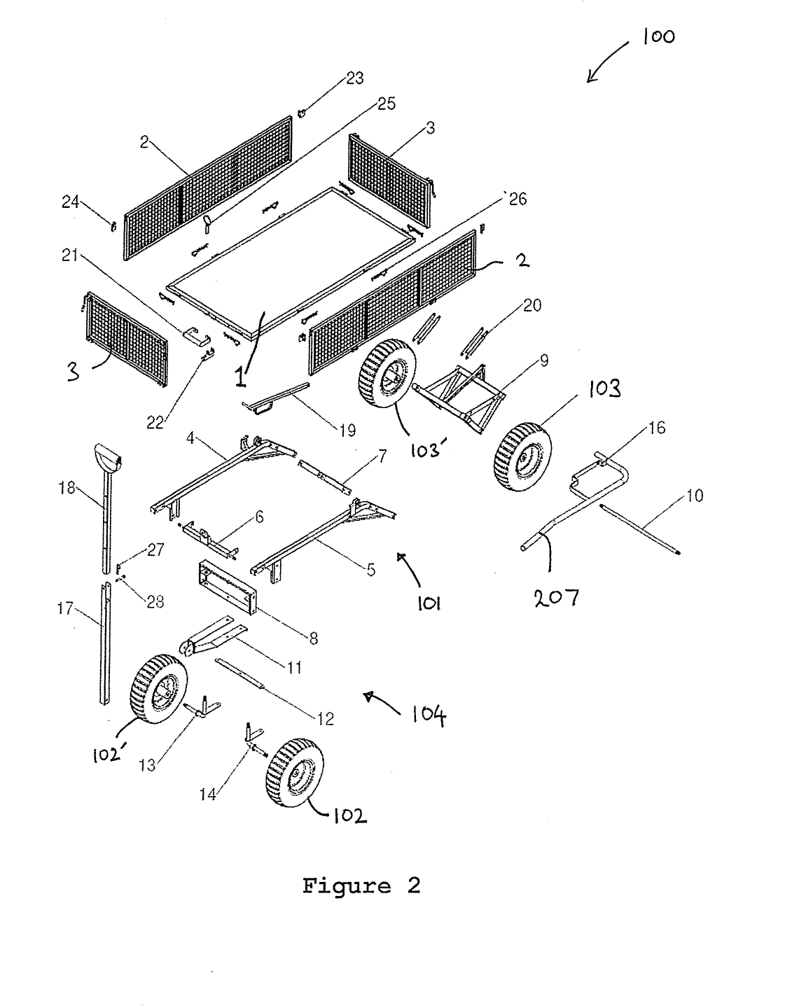

Referring to FIGS. 1 through 3, there is illustrated an embodiment of a dumping cart 100 having a chassis 101, a first pair of ground supporting wheels 102 located at a first end of the chassis and a second pair of ground supporting wheels 103 located at a second end of the chassis. The chassis 101 comprises a pair of chassis side rails 4, 5 and front and rear cross members 6, 7. In some embodiments, the chassis may comprise any number of side rails or cross members. In another embodiment, the chassis may be integrally formed as a single structure. The chassis defines a plane which is substantially parallel to the ground on which the dumping cart 100 rests during load carrying. The rear ends of the chassis side rails 4, 5 extend from that plane at a downwards angle to the rear end of the chassis 101. Preferably, the angle is an acute angle.

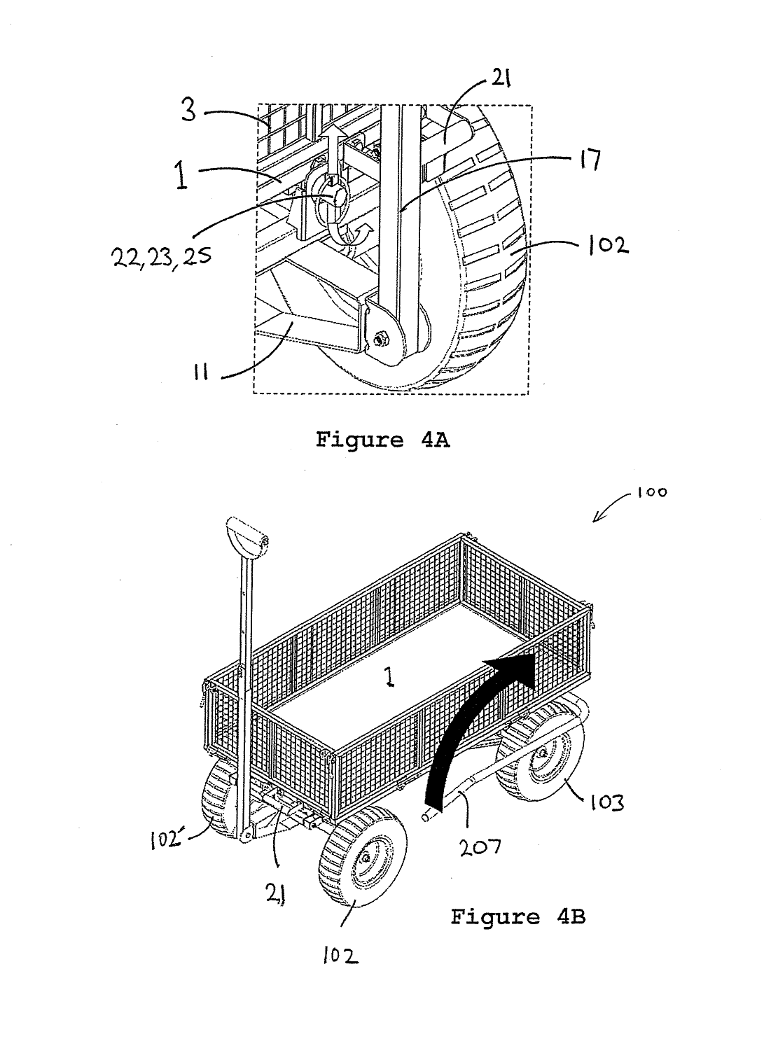

As best illustrated in FIG. 3, the second pair of wheels 103 is mounted to ends of a rear axle 10 and is rotational about a wheel axis 210. A tipping member 9 is pivotally connected with the rear of the chassis 101 along the wheel axis 210 and pivots about the wheel axis 210 between a load carrying position and an intermediate dumping position. Preferably, the tiping member has a triangular cross section. Yet in some other embodiments, the tipping member may be of any shape or structure. The tipping member 9 pivotally attaches a load carrying bed 1 to the chassis 101. The load carrying bed 1 is supported on the chassis 101 and is pivotally connected with the tipping member 9 about a dumping axis 206 which is spaced apart from the wheel axis 210. Preferably, the dumping axis and the wheel axis are both located on the tipping member. The load carrying bed 1 pivots about the dumping axis 206 between the intermediate dumping position and a load dumping position. It should be noted that the tipping member 9 being pivotal about the wheel axis 210 between the load carrying position and the intermediate dumping position and the bed 1 being pivotal with the tipping member 9 between the load carrying position and the load dumping position allows the bed 1 to dump past the rear wheels 103 but still fixes the distance between the front and rear wheels 102, 103 of the cart 100, such that throughout the pivotal dumping motion the distance between the front wheel axles 13, 14 and the rear wheel axle 10 remains substantially unchanged.

Referring to FIG. 3, in a preferred embodiment embodiment, a first pair of rollers 208 is located on the chassis side rails 4, 5 towards the rear of the chassis 101 and supports a rear end of the load carrying bed 1. A second pair of rollers 209 is located on the underside of the load carrying bed 1 towards the front of the bed 1 and cooperate with the chassis side rails 4, 5 for supporting the front end of the bed 1 on the chassis 101. The pairs of rollers 208, 209 providing a rolling support between the load carrying bed 1 and the chassis 101 facilitates a smooth movement of the bed 1 from the load carrying position to the intermediate dumping position. In some other embodiments, the first pair of rollers may be located towards the front or in the middle of the chassis whereas the second pair of rollers may be located towards the rear or in the middle of the underside of the load carrying bed to facilitate the smooth movement of the bed. In yet another embodiment, the dumping cart may only comprise one set of rollers located on the chassis or the underside of the load carrying bed.

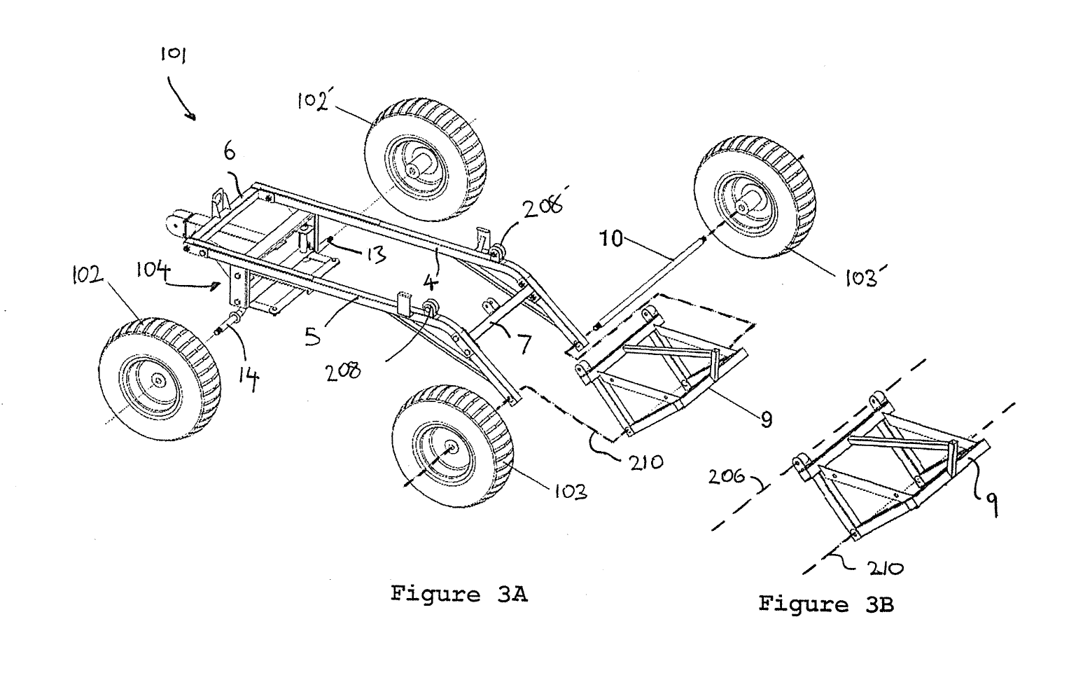

As shown in FIG. 2, a front steering assembly 104 is disposed at the front end of the chassis 101 and supports the set of front wheels 102 for connecting the wheels to the chassis. The front wheels 102 are rotational about the front wheel axles 13, 14. Preferably, a steering handle assembly 17, 18 is pivotally connected to the front steering assembly 104 by a steering bracket 11. In other embodiments, the handle assembly may be connected to the front steering assembly directly or through structures other than the steering bracket. Preferably, the steering handle assembly 17, 18 comprises two members in which the first member 18 has a handle (D-shaped handle) at one end and connects through a bolt 27, 28 to the second member 17 that is pivotally connected to the front steering assembly 104. In some other embodiments, the steering handle assembly may only comprise one handle member or any number of handle members. Also, alternatively, the handle can be of other shape and form. In a preferred embodiment, the length of the steering handle assembly 17, 18 can be flexibly adjusted by placing the bolt 27, 28 into different holes of the first member 18. In some embodiments, other length adjustment mechanism may be freely adapted in the steering handle assembly. In another embodiment, the first member 18 may be detached and the second member 17 may be connected to an external vehicle (not shown) such as a lawn tractor for towing the dumping cart 100.

As best illustrated in FIGS. 2 and 3, the set of rear wheels 103 is rotational about a rear wheel axis 210 and are disposed at the rear end of the chassis 101. In particular, the rear wheels 103 are connected to the ends of two side rails 4, 5 that extend from the plane at an angle at the rear end of the chassis 101. The tipping member 9 is pivotally connected to the chassis 101 about the rear wheel axis 210. The tipping member 9 allows the load carrying bed 1 that is supported by the chassis 101 and pivotally connected to the tipping member 9 along the dumping axis 206 to be actuated between the intermediate dumping position and the load dumping position. In particular, to facilitate the actuation of the tipping member 9 by the user, a handle 207 is connected to the tipping member 9 for actuating the tipping member externally. In some embodiments, the tipping member may be actuated externally by other mechanisms or structures other than a handle. Operation of the handle 207 pivots the tipping member 9 about the rear wheel axis 210 from the load carrying position to the intermediate dumping position. A second handle 21 is provided on the front end of the load carrying bed 1 to facilitate pivoting the bed about the dumping axis 206 from the intermediate dumping position to the load dumping position.

During the process of carrying a load, the load carrying bed 1 remains substantially parallel to the plane defined by the chassis 101 whereas in the intermediate dumping position or load dumping position, the load carrying bed 1 will be at an angle to the plane defined by the chassis 101. Preferably, the load carrying bed 1 may further comprise a plurality of interlocking side panels 2 and end panels 3 forming a load carrying box for holding goods in a more secure manner.

With reference to FIG. 2, a support bar 19 for supporting the weight of the load carrying bed 1 is disposed between the load carrying bed 1 and the chassis 101 to hold the load carrying bed in place during dumping. In addition, to secure the load carrying bed 1 during load transporting, a lock pin 22, 23, 25 is used for securing the load carrying bed to the chassis in the load carrying position. In other embodiments, the load carrying bed may be secured during load transporting by using other fixation members. Preferably, the supporting bar is a metal bar with a first end hinged to the rear end of chassis 101 and a second end in the form of T-shape freely slides along a rail 110 at the bottom of the load carrying bed 1. This mechanism keeps the load carrying bed in a tilted position and also avoids the load carrying bed from tumbling.

In the above examples, preferably, different parts of the dumping cart are made of metal. It is, however, possible that some of the parts are made from other materials including plastic, glass, polymeric materials, or any other suitable materials. Different parts of the dumping cart can be formed by moulding, casting or other mechanical processes. Also, in some embodiments, different parts are joined together by bolts, screws and pins. However, some of these parts may also be rigidly fixated. In yet another embodiment, different parts of the dumping cart may be integrally formed.

The advantages of the embodiment of the invention are that the load carrying bed 1 could be securely fixed to the chassis 101 even in the case when the handle 207 or lifting handle 21 is actuated accidentally. Also, the transition of the load carrying bed 1 from the load carrying position through the intermediate dumping position to the load dumping position can allow the user to better manage the load dumping process than going directly from the load carrying position to the load dumping position. During dumping, the support bar 19 could provide support to the load carrying bed 1 which may be loaded with goods and become very heavy. Lastly, as the distance between the two sets of wheels 102, 103 will remain substantially unchanged during load dumping, the dumping process could be steadier.

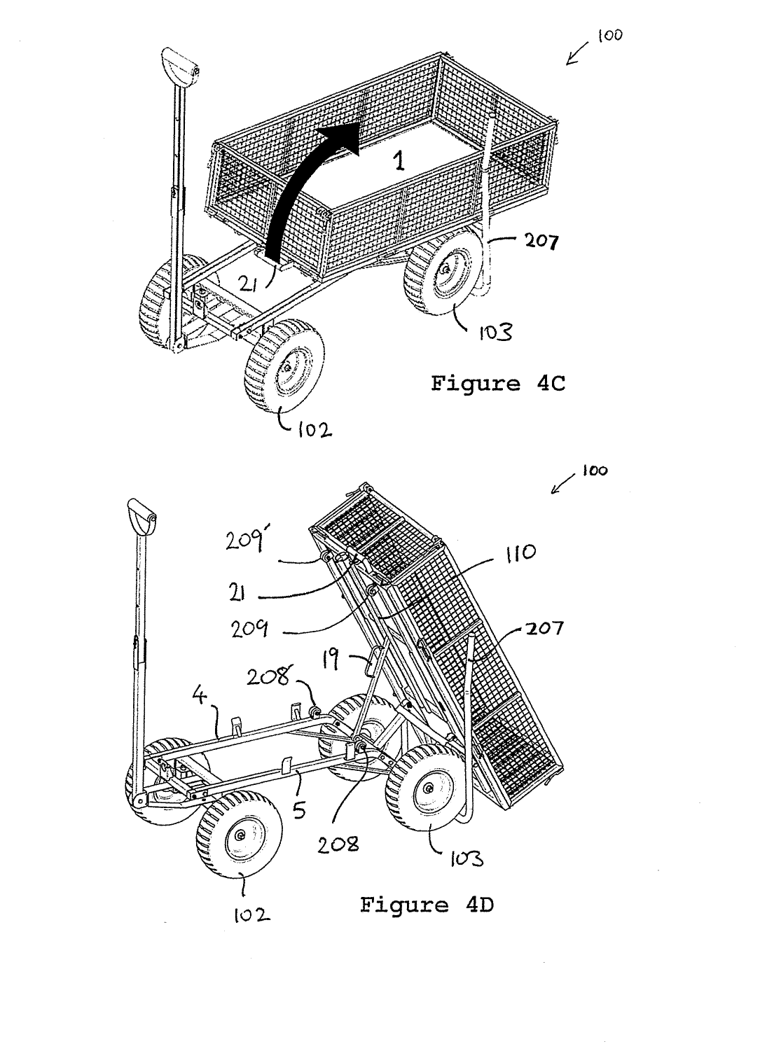

Referring to FIGS. 4A-D, there is illustrated an embodiment of the illustration of the procedures for actuating the dumping cart from the load carrying position to the load dumping position. Firstly, as shown in FIG. 4A, the lock pin 22, 23, 25 for locking the load carrying bed 1 to the chassis 101 is released by a user. Then, according to FIG. 4B, the handle 207 connecting to the tipping member 9 is actuated by the user upwardly and rearward to pivot the tipping member 9 about the wheel axis 210 to move the load carrying bed 1 from the load carrying position in FIG. 4B to the intermediate dumping position shown in FIG. 4C. The bed 1 is transported along the chassis 101 on rollers 208, 209. Thirdly, the user lifts handle 21 of the load carrying bed 1 to pivot the load carrying bed about the dumping axis 206 from the intermediate dumping position to the load dumping position shown in FIG. 4D. The support bar 19 is used to support the load carrying bed 1 in the load dumping position while the user clears the bed tray. After the load is dumped, the bed 1 can be returned to the load carrying position via the opposite steps.

It will be appreciated by persons skilled in the art that numerous variations and/or modifications may be made to the invention as shown in the specific embodiments without departing from the spirit or scope of the invention as broadly described. The present embodiments are, therefore, to be considered in all respects as illustrative and not restrictive.

Any reference to prior art contained herein is not to be taken as an admission that the information is common general knowledge, unless otherwise indicated.

1. A dumping cart comprising:
a chassis,
a first pair of supporting wheels located at a first end of the chassis,
a second pair of supporting wheels located at a second end of the chassis, the second pair of wheels being rotational about a wheel axis,
a load carrying bed supported on the chassis and pivotable about a dumping axis between an intermediate dumping position and a load dumping position, and
a tipping member pivotally connected with the chassis along the wheel axis and pivotally connected with the bed along the dumping axis, wherein the tipping member pivots about the wheel axis to move the bed between a load carrying position and the intermediate dumping position.

2. The dumping cart of claim 1, including a handle connected to the tipping member for actuating the tipping member, wherein the handle is in a first position in the load carrying position and a second position in the intermediate dumping position.

3. The dumping cart of claim 1, wherein
the chassis comprises a plurality of frame members that define a first plane substantially parallel to the ground on which the first and second pairs of supporting wheels are supported, and
two of the frame members extend from the first plane at an angle and connect with the tipping member.

4. The dumping cart of claim 3, wherein the load carrying bed is substantially parallel to the first plane in the load carrying position and not parallel to the first plane in the intermediate dumping position and the load dumping position.

5. The dumping cart of claim 1, including a lift handle connected to the load carrying bed, wherein the lift handle can be actuated to allow the load carrying bed to pivot about the dumping axis, between the intermediate dumping position and the load dumping position.

6. The dumping cart of claim 1, including a support bar with one end pivotally connected to the chassis and a second end connected to the load carrying bed and supporting the load carrying bed in the load dumping position.

7. The dumping cart of claim 1, including a steering assembly and a steering handle assembly that is pivotally connected to the steering assembly that that is connected to the chassis, wherein
the steering handle assembly comprises first and second members and a handle,
the first member is connected to second member, and
the handle is located at one end of the first member.

8. The dumping cart of claim 7, wherein the second member may be connected to an external vehicle that drives the dumping cart, instead of being connected to the first member.

9. The dumping cart of claim 1, including a lock pin that locks the load carrying bed to the chassis in the load carrying position.

10. The dumping cart of claim 1 further including a supporting bar pivotally connected with the chassis at a first end of the bar and slidably engaging the load carrying bed at the second end of the bar, wherein the supporting bar supports the load carrying bed in the load dumping position.

11. The dumping cart of claim 1 further comprising rollers supporting the load carrying bed on the chassis.

12. The dumping cart of claim 11 wherein the rollers comprise at least a first pair of rollers on the chassis and a second pair of rollers on the load carrying bed.
